(19) United States
(12) Patent Application Publication
(10) Pub. No.: US 2026/0267860 A1
(43) Pub. Date: Sep. 10, 2026

(54) SEMANTIC RELEVANCE-BASED RESPONSE GENERATION SYSTEM USING AI AND SIMILARITY MEASURES

(71) Applicant: AT&T Intellectual Property I, L.P., Atlanta, GA (US)

(72) Inventors: Vladimir Sevastyanov, Fort Worth, TX (US); VENKATA SESHA SAI KOUNDINYA GOPARAJU, MCKINNEY, TX (US); Rakhi Gupta, Frisco, TX (US); Abhay Dabholkar, Allen, TX (US)

(73) Assignee: AT&T Intellectual Property I, L.P., Atlanta, GA (US)

(21) Appl. No.: 19/069,352

(22) Filed: Mar. 4, 2025

(51) Int. Cl. G06F 16/2457; G06F 40/30

(52) U.S. Cl. CPC G06F 16/24575; G06F 40/30

(57) ABSTRACT

Aspects of the subject disclosure may include, for example, a system that enhances natural language processing by integrating AI models with similarity measures to generate contextually accurate responses. A user query is received, and a similarity measure between the user query and a store of potential answers is determined. Top potential answers are determined based on the similarity measures. The top potential answers are included in a prompt that is provided to an AI model, which identifies the most relevant answer. Other embodiments are disclosed.

### FIELD OF THE DISCLOSURE

The subject disclosure relates to systems and methods for enhancing response generation in natural language processing.

### BACKGROUND

Traditional methods for generating responses to user queries in natural language processing systems either rely solely on pre-trained language models or simple retrieval-based systems. These methods often fail to deliver highly relevant and contextually accurate responses due to their inability to effectively evaluate semantic relevance. Furthermore, these methods are computationally expensive as they require the model to generate a response from scratch or sift through a vast amount of data to retrieve a relevant response.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B and 2C depict illustrative embodiments of methods in accordance with various aspects described herein.

FIG. 2D is a table illustrating an example, non-limiting embodiment of a fragment of a knowledge base including examples of resolutions taken from historical data.

FIG. 2E is a diagram illustrating Python code for prompt construction.

FIG. 2F depicts an illustrative embodiment of a method in accordance with various aspects described herein.

FIG. 2G is a diagram illustrating Python code for prompt construction.

FIG. 2H is a table illustrating a fragment of a repository containing snippets of source code.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enhancing natural language response accuracy using AI models and similarity measures for efficient production and selection of contextually relevant answers. Other embodiments are described in the subject disclosure.

Various embodiments described herein provide systems and methods that enhance the precision, efficiency, and effectiveness of semantic ranking in delivering highly relevant search results. These embodiments leverage an Artificial Intelligence (AI) (e.g., Generative Pretrained Transformer ‘GPT’)-based system combined with a structured approach to ensure that responses to user queries are well-informed and contextually appropriate. By integrating quantitative similarity measures with the qualitative strengths of an AI model, the various embodiments improve accuracy and semantic relevance.

A set of potential answers to a user query are retrieved from a comprehensive knowledge base. A similarity measure (e.g., cosine similarity) is calculated between the user query and this set of potential answers to determine which are most semantically similar. This step is computationally efficient and does not require a GPT call, allowing for the efficient evaluation of cosine similarity for all candidates in the knowledge base. The top N similar answers are then selected for further processing.

These top N answers are fed into the GPT model within a specially constructed prompt. The GPT model evaluates the provided options and identifies the most semantically relevant answer. This answer serves as the basis for generating a precise and contextually accurate response to the original query. This multi-step process enhances the reliability and relevance of the output, ensuring that users receive high-quality answers tailored to their specific queries.

Various embodiments described herein can be applied in multiple domains, such as a ticket analyzer for resolving technical issues and a snippet finder for retrieving relevant code (e.g., Python) snippets. In the ticket analyzer embodiment, the system accesses a knowledge base of archived technical support tickets, calculates cosine similarity to find the most relevant historical resolutions, and uses the GPT model to generate actionable recommendations. In the snippet finder embodiment, the system retrieves and evaluates Python snippets to provide users with the most relevant code based on their descriptions.

By combining vector similarity calculations with deep language understanding, the various embodiments described herein enhance the efficiency and accuracy of natural language processing tasks, making it suitable for large-scale operations in customer support, information retrieval, and beyond.

One or more aspects of the subject disclosure include a device, comprising a processing system including a processor and a memory that stores executable instructions that, when executed by the processing system, facilitate performance of operations. The operations may include receiving a user query; retrieving, from a data store, a set of potential answers to the user query; calculating a similarity measure between the user query and each potential answer from the set of potential answers; selecting, based on the similarity measure, N potential answers from the set of potential answers; constructing a prompt including the N potential answers; providing the prompt to an artificial intelligence (AI) model; receiving, from the AI model, an identification of a most semantically relevant answer from the N potential answers; and generating a response to the user query based on the most semantically relevant answer.

One or more aspects of the subject disclosure include a non-transitory machine-readable medium, comprising executable instructions that, when executed by a processing system including a processor, facilitate performance of operations. The operations may include receiving a domain-specific user query; retrieving, from a domain-specific knowledge base, a set of potential answers to the domain-specific user query; calculating a similarity measure between the domain-specific user query and each potential answer from the set of potential answers; selecting, based on the similarity measure, N potential answers from the set of potential answers; constructing a prompt including the N potential answers; providing the prompt to an artificial intelligence (AI) model; receiving, from the AI model, an identification of a most semantically relevant answer from the N potential answers; and generating a response to the domain-specific user query based on the most semantically relevant answer.

One or more aspects of the subject disclosure include a method, comprising: receiving, by a processing system including a processor, a domain-specific user query; calculating, by the processing system, a cosine similarity measure between the domain-specific user query and each potential answer from a set of domain-specific potential answers; selecting, by the processing system and based on the cosine similarity measure, N potential answers from the set of potential answers; constructing, by the processing system, a prompt including the N potential answers; providing, by the processing system, the prompt to an artificial intelligence (AI) model; receiving, by the processing system and from the AI model, an identification of a most semantically relevant answer from the N potential answers; and generating, by the processing system, a response to the domain-specific user query based on the most semantically relevant answer.

Additional aspects of the subject disclosure may include calculating the similarity measure using cosine similarity to enhance semantic relevance; providing the prompt to a Generative Pretrained Transformer (GPT) model for advanced semantic analysis; wherein the data store comprises a knowledge base that includes at least one text string and may also include a structured database; calculating the similarity measure using term frequency-inverse document frequency (TF-IDF) scores to improve the accuracy of potential answer selection; filtering the top N potential answers using a context-aware mechanism that considers the semantic context of the user query; wherein the data store includes metadata tagging to improve retrieval and ranking of potential answers, and may also include computer code snippets and archived technical support tickets; preprocessing the user query to improve semantic understanding before calculating the similarity measure; constructing the prompt using a template that emphasizes the most relevant sections of the top N potential answers; integrating a feedback loop to continuously update and refine the knowledge base and model performance based on user interactions; providing a user interface that allows users to manually select from the top N potential answers if the automated response is deemed insufficient; performing the cosine similarity calculation in a distributed computing environment to handle large-scale knowledge bases efficiently; fine-tuning the AI model on a domain-specific dataset to improve its performance in identifying the most semantically relevant answer; and employing natural language understanding (NLU) techniques to preprocess the user query and improve the accuracy of subsequent steps.

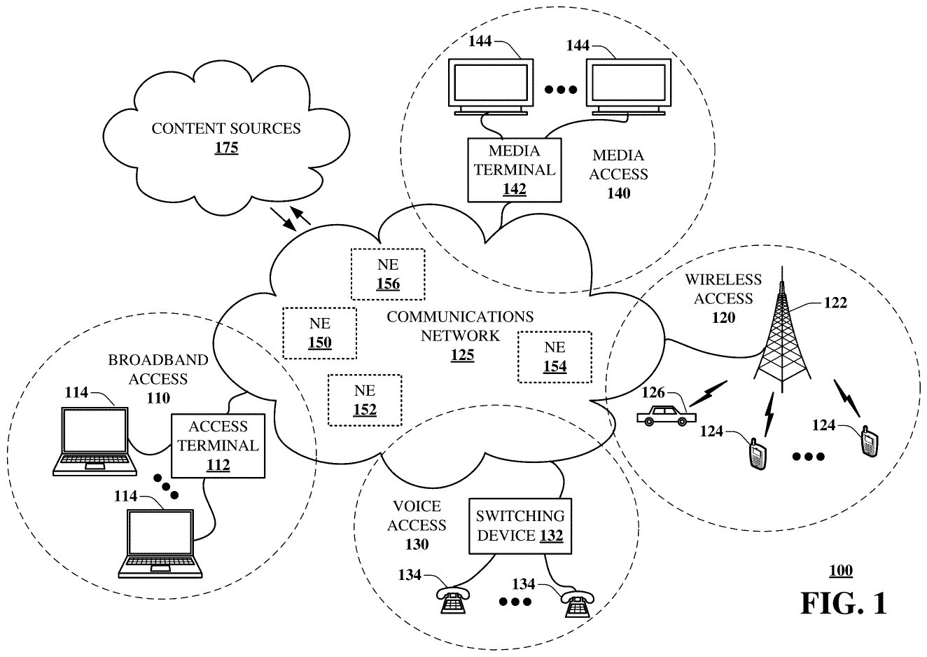

Referring now to FIG. 1, a block diagram is shown illustrating an example, non-limiting embodiment of a system 100 in accordance with various aspects described herein. For example, system 100 can facilitate in whole or in part enhancing natural language response accuracy using AI models and similarity measures for efficient production and selection of contextually relevant answers. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In FIG. 1, the communications network 125 can implement various portions of the embodiments described herein. For example, network elements 150, 152, 154, and 156 within the system 125 may host the knowledge base or perform similarity calculations and AI model evaluations as described herein. These network elements can facilitate the retrieval and processing of data, enabling the system to generate contextually relevant responses efficiently. The broadband access 110 and wireless access 120 components ensure that data terminals 114 and mobile devices 124 can interact with the system seamlessly, allowing users to input queries and receive responses in real-time. Additionally, the media access 140 and voice access 130 components can support diverse modes of user interaction, further enhancing the system's versatility. By leveraging the robust infrastructure of the communications network, the various embodiments can deliver high-quality, contextually accurate responses across various applications, showcasing its novel integration with existing network resources.

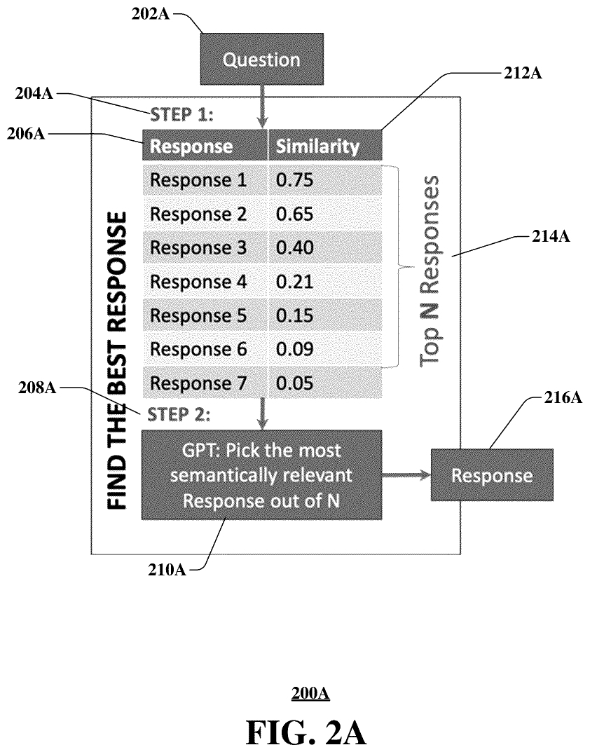

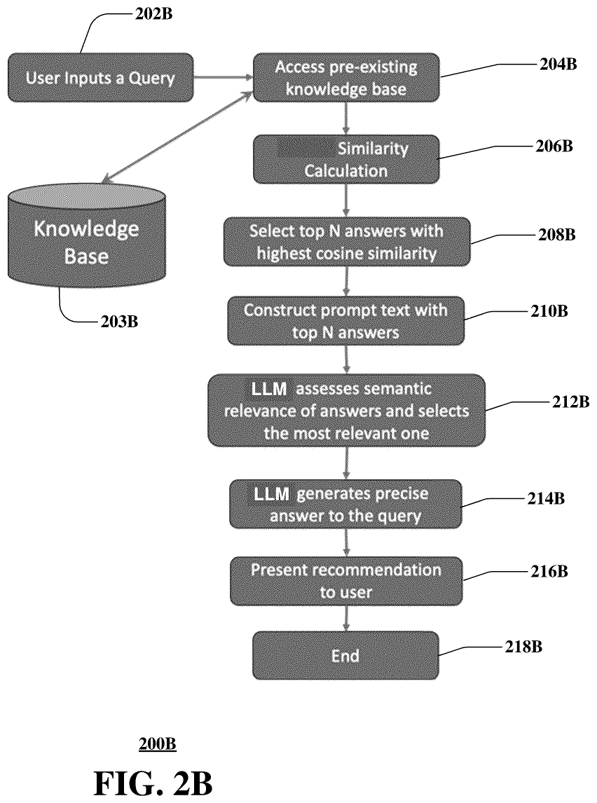

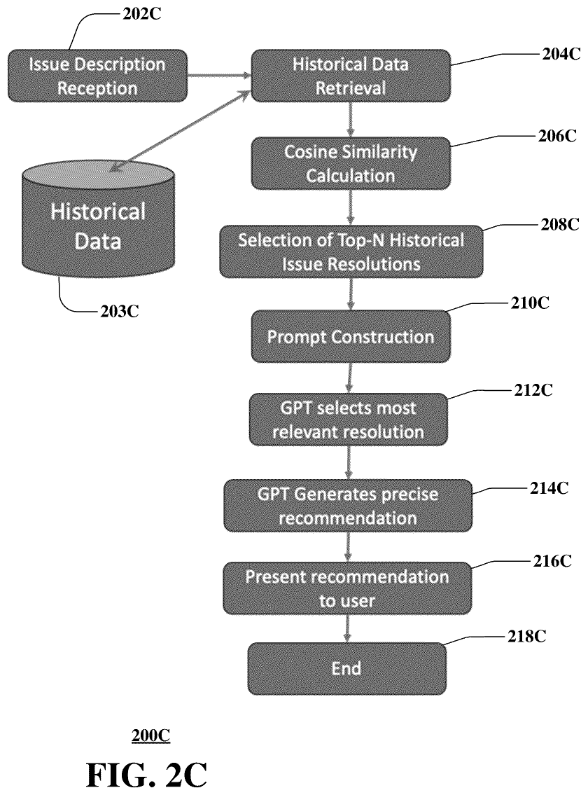

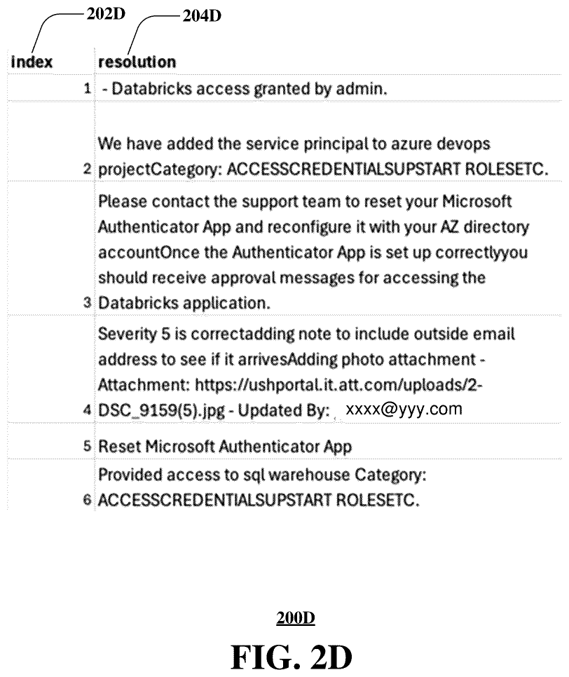

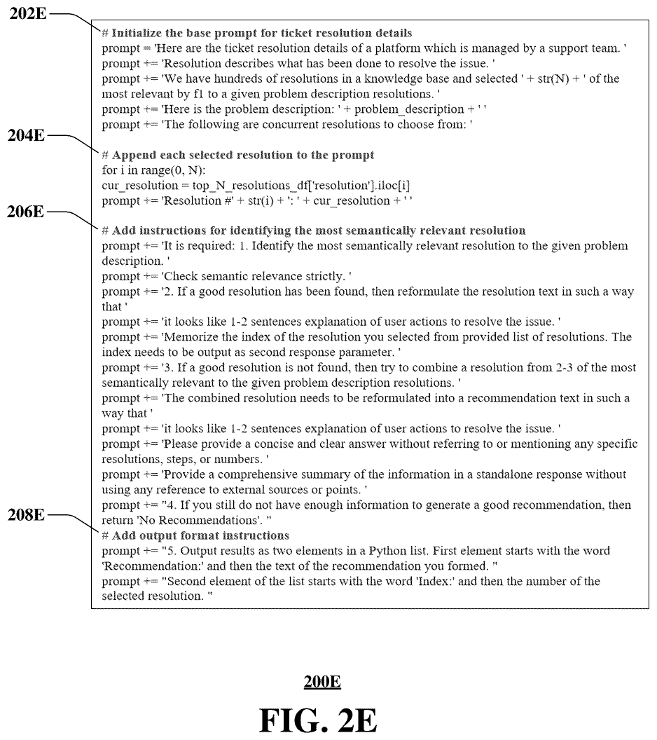

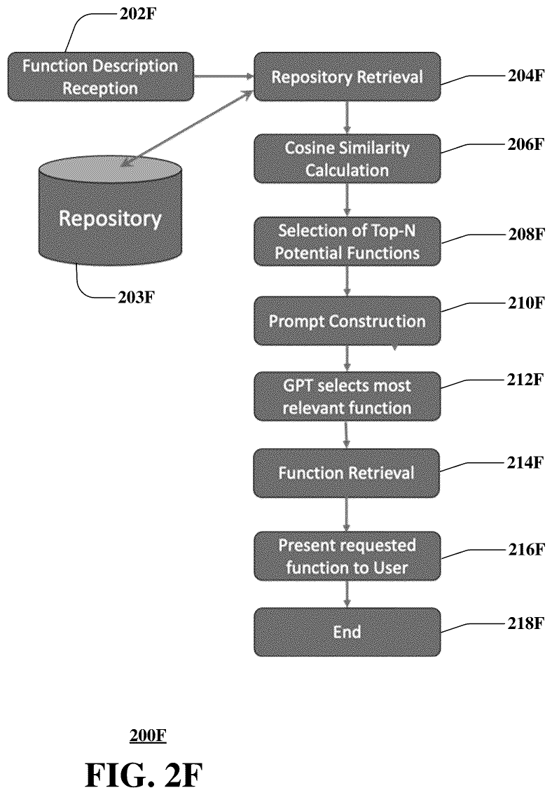

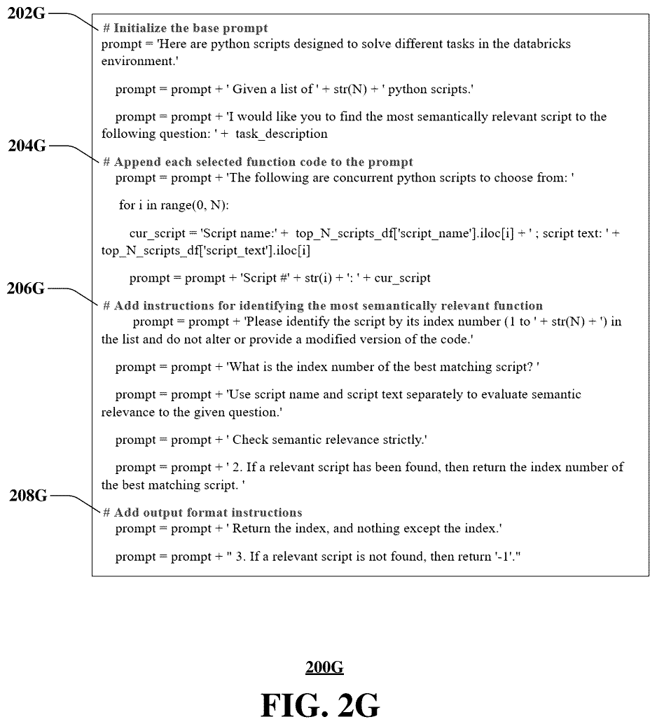

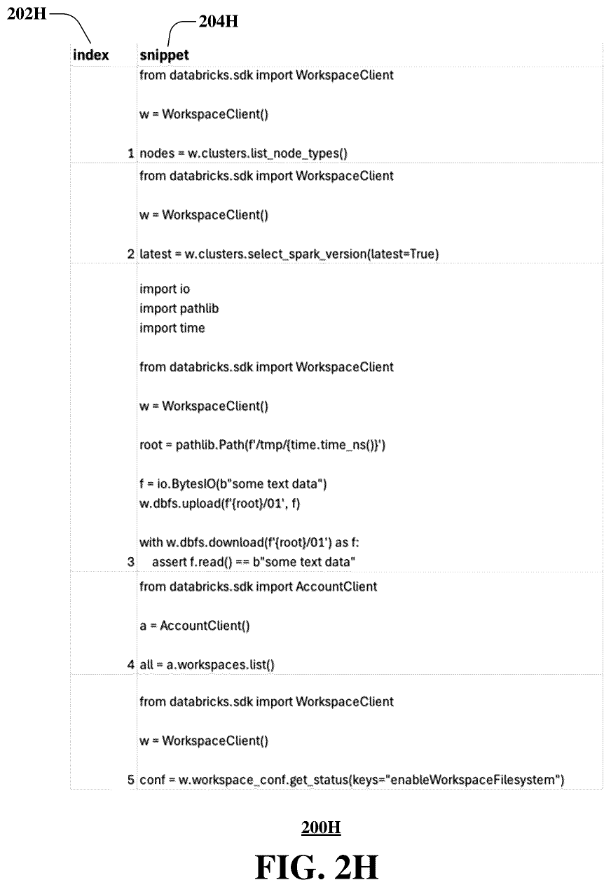

FIG. 2A is a block diagram illustrating an example, non-limiting embodiment of a system functioning within the communication network of FIG. 1 in accordance with various aspects described herein. FIG. 2A illustrates a process flow for generating a contextually accurate response to a user query using a semantic relevance-based system. The process begins with a user inputting a question, labeled as 202A. The first step, indicated by 204A, involves retrieving potential response candidates from a knowledge base, denoted as 206A. A similarity measure, such as cosine similarity, is calculated for each response candidate, as shown by 212A. The system then selects the top N response candidates, marked as 214A, based on their similarity scores. In the second step, represented by 208A, these top N candidates are fed into a large language model (LLM), labeled as 210A, which evaluates and identifies the most semantically relevant answer. Finally, the system generates a response, indicated by 216A, based on the selected answer, ensuring that the output is precise and contextually appropriate.

In some embodiments, the system represented by FIG. 2A may be employed in various types of systems where domain-specific queries and responses are critical. For example, in a technical support system, the user query may be a description of a technical issue, and the knowledge base may include archived support tickets and resolutions. In these embodiments, the similarity measure helps identify the most relevant past solutions, allowing the system to generate accurate recommendations for resolving current issues.

Also for example, in a medical diagnosis system, the user query might be a set of symptoms or a medical condition, and the knowledge base may include medical records, research papers, and treatment protocols. The system calculates similarity within this medical domain to suggest potential diagnoses or treatment options.

In a further example, such as a legal research system, the user query could be a legal question or case detail, and the knowledge base may include legal documents, case law, and statutes. The similarity measure may help find relevant legal precedents or interpretations, aiding in legal research and decision-making. Further, in an educational tutoring system, the user query may be a student's question on a specific subject, and the knowledge base may consist of educational materials, textbooks, and past exam questions. The system may use the similarity measure to provide the most relevant explanations or study resources. Still further, in a financial advisory system, the user query may be a financial question or investment scenario, and the knowledge base may include market data, financial reports, and investment strategies. The system may calculate similarity to offer tailored financial advice or investment recommendations. These examples illustrate how systems represented in FIG. 2A can be adapted to various domains, leveraging domain-specific knowledge bases to enhance the relevance and accuracy of generated responses.

While for purposes of simplicity of explanation, the respective processes are shown and described as a series of blocks in FIG. 2A and in following figures, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIGS. 2B and 2C depict illustrative embodiments of methods in accordance with various aspects described herein. Referring to FIG. 2B, at block 202B, method 200B begins with a user inputting a query into the system. This input can be facilitated through various interfaces, such as a web-based form, a mobile application, or a voice-activated assistant. In some embodiments, the user interface is designed to accommodate natural language input, allowing users to type or speak their queries in a conversational manner. For example, a user might enter a question about troubleshooting a technical issue or request information on a specific topic. The system is configured to interpret the user's input, regardless of the format, and proceed with accessing the pre-existing knowledge base, as indicated by the subsequent steps in the process. This query is then used to access a pre-existing knowledge base, as indicated by block 204B. The knowledge base, labeled as 203B, can be any type of data store, such as text documents, relational databases, or other structured or unstructured data repositories. It may be located anywhere, including on local servers or in the cloud, providing flexibility in how data is stored and accessed. For example, a cloud-based knowledge base might allow for scalable storage and easy access from multiple locations.

Once a user inputs a query at block 202B, the system proceeds to transform this input into a mathematical representation suitable for similarity calculations. This transformation involves vectorizing the query, which is a process of converting the text into a numerical format that can be processed by the system. In some embodiments, this is achieved by using a pre-trained language model or a mapping function to generate a vector representation of the query. For example, the model might analyze the query's words and their relationships to produce a vector that captures the semantic meaning of the input. This vectorization allows the system to perform similarity calculations, such as cosine similarity, by comparing the query vector with vectors of potential answers stored in the knowledge base 203B.

At block 206B, a similarity calculation is performed to determine the relevance of each potential answer in the knowledge base to the user query. In some embodiments, this involves calculating similarity measures, such as cosine similarity, to evaluate semantic relevance. Other examples of similarity measures might include Jaccard index or Euclidean distance, which allow for efficient comparison of the query with potential answers.

At block 208B, the system selects the top N answers with the highest similarity scores. In some embodiments, this selection process ensures that only the most semantically similar answers are considered for further processing. For example, the top N answers might be those that most closely match the query in terms of context and content. At block 210B, a prompt text is constructed using these top N answers. In some embodiments, this prompt is designed to guide the large language model (LLM) in evaluating the semantic relevance of the answers. For example, the prompt might highlight key aspects of the top N answers to focus the LLM's analysis.

In determining the top N answers, in some embodiments, the system may utilize various metadata alongside similarity measures to enhance the accuracy and relevance of the selection process. One such approach involves the use of term frequency-inverse document frequency (TF-IDF) scores, which help in identifying the importance of terms within the context of the knowledge base. By assigning higher weights to terms that are more significant in the user query compared to the entire dataset, TF-IDF scores can improve the precision of the similarity calculation. Additionally, metadata tagging within the knowledge base can further refine the retrieval and ranking of potential answers. Tags may include information about the context, domain, or specific attributes of the data, allowing the system to filter and prioritize answers that are most relevant to the user's query.

At block 212B, the LLM assesses the semantic relevance of the answers and selects the most relevant one. In some embodiments, the LLM uses its deep understanding of language and context to make this determination. Examples of LLMs that may be used include Generative Pretrained Transformers (GPT), BERT, or T5, each offering unique capabilities in processing and understanding natural language. For example, GPT models are known for their generative capabilities, while BERT excels in understanding context through bidirectional training. At block 214B, the LLM generates a precise answer to the query based on the selected answer. In some embodiments, this involves synthesizing information from the selected answer to create a response that is both accurate and contextually appropriate. For example, the LLM might generate a detailed explanation or a concise recommendation.

The large language model (LLM) used in the system can be either a generic model or one that has been trained or fine-tuned on a domain-specific dataset to enhance its performance. A generic LLM, such as a standard version of GPT, BERT, or T5, is capable of understanding and generating responses across a wide range of topics due to its extensive pre-training on diverse datasets. However, to improve accuracy and relevance in specific domains, the LLM can be fine-tuned on a dataset that is tailored to the particular field of interest. For example, in a ticketing system, the LLM might be fine-tuned using historical support tickets and resolutions to better understand technical terminology and context. Similarly, in a code snippet retrieval system, the model could be trained on a repository of code snippets and programming documentation to enhance its ability to interpret coding queries. This domain-specific training allows the LLM to leverage its deep language understanding while being more attuned to the nuances and specificities of the domain, resulting in more precise and contextually relevant responses.

At block 216B, the generated recommendation is presented to the user. In some embodiments, this presentation might include additional context or options for further action. For example, the user might receive a summary of the recommendation along with links to related resources. Finally, at block 218B, the process concludes, having provided the user with a high-quality, relevant answer to their query.

In some embodiments, the system may include a feedback loop where user interactions and feedback are continuously used to update and refine the knowledge base and model performance. This feedback loop allows the system to learn from user experiences, adapting to new information and improving its response accuracy over time. For example, when a user interacts with the system and provides feedback on the relevance or accuracy of a response, this information can be used to adjust the similarity measures or update the knowledge base with new data. Additionally, the feedback can inform the fine-tuning of the large language model (LLM), ensuring it remains aligned with user expectations and domain-specific requirements. By incorporating user feedback, the system becomes more robust and capable of delivering high-quality, contextually relevant answers, ultimately enhancing user satisfaction and system reliability.

FIG. 2C illustrates a method 200C for resolving technical issues using historical data and a GPT model, representing an application of the system described with reference to FIGS. 2A and 2B. For example, method 200C embodies a domain-specific example of the general method described with respect to FIGS. 2A and 2B. In these embodiments, the issue description reception at block 202C corresponds to a domain-specific user query, where a user inputs a description of a technical problem, and historical data 203C corresponds to a domain specific knowledge base that includes historical ticket resolutions. At block 202C, the process begins with the reception of an issue description from a user, similar to the query input in FIG. 2A. This description is used to access historical data, labeled as 203C, which contains records of previously resolved issues. At block 204C, the system retrieves relevant historical data, akin to the retrieval of potential answers in FIG. 2B. At block 206C, it calculates a similarity measure to evaluate the relevance of each historical resolution to the current issue. While cosine similarity is used as an example, various embodiments are not limited to this measure and may include other similarity measures such as Jaccard index or Euclidean distance. This step mirrors the similarity calculation process in FIG. 2B, allowing the system to efficiently compare the issue description with historical resolutions.

At block 208C, the system selects the top N historical issue resolutions with the highest similarity scores, ensuring that only the most relevant past solutions are considered for further processing. This selection process is analogous to the selection of top N answers in FIG. 2B. At block 210C, a prompt is constructed using these top N resolutions, designed to guide the GPT model in evaluating their relevance, similar to the prompt construction in FIG. 2B. At block 212C, the GPT model assesses the semantic relevance of the resolutions and selects the most appropriate one, reflecting the evaluation process in FIG. 2A.

The model then generates a precise recommendation at block 214C, synthesizing information from the selected resolution to create a contextually accurate response. At block 216C, the generated recommendation is presented to the user, providing actionable insights for resolving the issue. Finally, at block 218C, the process concludes, having delivered a high-quality, relevant recommendation to the user. This process exemplifies how the system leverages historical data and advanced language models to enhance the efficiency and accuracy of technical support operations, showcasing the novel integration of similarity measures and GPT evaluation to deliver precise solutions.

While for purposes of simplicity of explanation, the respective processes are shown and described as a series of blocks in FIGS. 2B, 2C and in following figures, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D is a table illustrating an example, non-limiting embodiment of a fragment of a knowledge base including examples of resolutions taken from historical data. FIG. 2D includes the table 200D, which in turn includes index 202D and resolution 204D, which, in some embodiments, correspond to elements of a knowledge base used in the system. For example, in some embodiments, the table 200D may represent a fragment of the knowledge base from FIG. 2C, which may include various records of historical resolutions. In some embodiments, the table 200D may be implemented as a database or a structured data repository. For example, it may store detailed logs of technical support resolutions. The index 202D denotes the reference for each resolution entry, providing a way to identify specific resolutions. In some embodiments, this index may be implemented as a numerical or alphanumeric identifier. For example, in some embodiments, it may be a sequential number or a unique code assigned to each entry. The resolution 204D represents the text associated with each index entry, detailing the specific actions taken to resolve past issues. In some embodiments, this resolution text may be implemented as a text string or document. For example, in some embodiments, it may include step-by-step instructions or a summary of the resolution process.

The resolution text from the knowledge base, as depicted in FIG. 2D, is compared to the user query using a similarity measure as described above. For example, at block 206C of FIG. 2C, the system calculates a similarity measure, such as cosine similarity, to evaluate the relevance of each resolution text 204D to the issue description received at block 202C. This involves transforming both the user query and the resolution text into vector representations, allowing for a mathematical comparison of their semantic content. The similarity measure helps identify which resolutions in the table 200D are most closely aligned with the user's query. By leveraging this comparison, the system can efficiently select the top N historical issue resolutions at block 208C, ensuring that the most relevant past solutions are considered for further processing. This integration of similarity measures with historical data retrieval exemplifies the novel approach of using structured data to enhance the accuracy and relevance of generated responses.

FIG. 2E is a diagram illustrating Python code for prompt construction. FIG. 2E illustrates a sequence of steps involved in constructing a prompt for ticket resolution details, represented by steps 202E, 204E, 206E, and 208E, with the code implementation shown as 200E. At step 202E, the process begins by initializing the base prompt for ticket resolution details. In some embodiments, this involves setting up a framework that outlines the context of the ticket resolution, such as stating that the prompt includes details managed by a support team. For example, the prompt might include a statement like “Here are the ticket resolution details of a platform which is managed by a support team.”

At step 204E, each selected resolution is appended to the prompt. In some embodiments, this involves iterating over the top N resolutions and incorporating them into the prompt text. For example, the system might append each resolution with its index to maintain clarity and reference within the prompt.

Step 206E involves adding instructions for identifying the most semantically relevant resolution. In some embodiments, this step includes directives for the system to determine the most appropriate resolution based on the given problem description. For example, the prompt might instruct the system to “Identify the most semantically relevant resolution to the given problem description.”

At step 208E, additional output format instructions are added to the prompt. In some embodiments, this involves specifying how the output should be structured, such as formatting the results in a Python list. For example, the prompt might include instructions like “Output results as two elements in a Python list.”

The code 200E represents the implementation of these steps, providing a structured approach to dynamically generate the prompt. This process exemplifies the novel integration of structured prompt construction and semantic analysis to enhance the accuracy and relevance of the generated recommendations.

FIG. 2F depicts an illustrative embodiment of a method in accordance with various aspects described herein. FIG. 2F illustrates a flowchart 200F detailing the process of retrieving relevant code snippets, serving as a domain-specific example of the general method described above. At block 202F, the process begins with the reception of a function description from a user, similar to the domain-specific user query in previous figures. This description is used to access a repository, labeled as 203F, which contains a collection of Python snippets. The repository may include source code files or a structured database with metadata, providing a comprehensive resource for code retrieval. For example, the repository might store snippets with associated metadata tags that describe the function's purpose or usage context.

At block 204F, the system retrieves relevant snippets from the repository, akin to the retrieval of potential answers in earlier figures. At block 206F, the system performs vectorization of the function description, converting it into a numerical vector representation. Similarly, each snippet in the repository is also vectorized. The system then calculates a similarity measure, such as cosine similarity, between the function description vector and each snippet vector. This step mirrors the similarity calculation process in previous figures, allowing the system to efficiently compare the function description with the snippets. At block 208F, the system selects the top N snippets with the highest similarity scores, ensuring that only the most relevant snippets are considered for further processing. This selection process is analogous to the selection of top N answers in earlier figures.

At block 210F, a prompt is constructed using these top N snippets, designed to guide the GPT model in evaluating their relevance. At block 212F, the GPT model assesses the semantic relevance of the snippets and selects the most appropriate one, reflecting the evaluation process in previous figures. The model then retrieves the precise function at block 214F, synthesizing information from the selected snippet to create a contextually accurate response.

At block 216F, the retrieved function is presented to the user, providing the exact code snippet requested. Finally, at block 218F, the process concludes, having delivered a high-quality, relevant function to the user. This process exemplifies how the system leverages a repository of code snippets and advanced language models to enhance the efficiency and accuracy of code retrieval operations, showcasing the novel integration of similarity measures and GPT evaluation to deliver precise solutions.

FIG. 2G is a diagram illustrating Python code for prompt construction. FIG. 2G illustrates a sequence of steps involved in constructing a prompt for retrieving relevant Python scripts, represented by steps 202G, 204G, 206G, and 208G, with the code implementation shown as 200G. At step 202G, the process begins by initializing the base prompt for script retrieval. In some embodiments, this involves setting up a framework that outlines the context of the task, such as stating that the prompt includes Python scripts designed to solve different tasks in a databricks environment. For example, the prompt might include a statement like “Here are Python scripts designed to solve different tasks in the databricks environment.”

At step 204G, each selected function code is appended to the prompt. In some embodiments, this involves iterating over the top N scripts and incorporating them into the prompt text. For example, the system might append each script with its name and text to maintain clarity and reference within the prompt.

Step 206G involves adding instructions for identifying the most semantically relevant function. In some embodiments, this step includes directives for the system to determine the most appropriate script based on the given task description. For example, the prompt might instruct the system to “Please identify the script by its index number in the list and do not alter or provide a modified version of the code.”

Consider the following task description: “Our ADO repository workspace is no longer allow listed, and we cannot access our repositories or commit changes.” GPT identifies the following snippet:
from databricks.sdk import WorkspaceClient
from databricks.sdk.service import workspace
w=WorkspaceClient( )
all=w.repos.list(workspace.ListReposRequest( ))

This code snippet programmatically lists repositories, which corresponds to the task description.

At step 208G, additional output format instructions are added to the prompt. In some embodiments, this involves specifying how the output should be structured, such as returning only the index of the best matching script. For example, the prompt might include instructions like “Return the index, and nothing except the index.”

The code 200G represents the implementation of these steps, providing a structured approach to dynamically generate the prompt. This process exemplifies the novel integration of structured prompt construction and semantic analysis to enhance the accuracy and relevance of the generated script recommendations.

FIG. 2H is a table illustrating a fragment of a repository containing snippets of source code. FIG. 2H includes the table 200H, index 202H, and snippet 204H, which correspond to elements of a repository used in the system. The table 200H represents a fragment of the repository from which code snippets are retrieved, similar to the knowledge base described in previous figures. In some embodiments, the table 200H may be implemented as a structured data repository or a database that stores various code snippets. For example, it could contain Python scripts designed to perform specific tasks within a databricks environment.

The index 202H provides a reference for each snippet entry, allowing for easy identification and retrieval. In some embodiments, this index may be implemented as a numerical or alphanumeric identifier. For example, it could be a sequential number or a unique code assigned to each snippet. The snippet 204H represents the actual code associated with each index entry, detailing the specific functionality of the code. In some embodiments, this snippet text may be implemented as a text string or document. For example, it could include code for listing nodes, selecting spark versions, or managing workspace configurations.

In some embodiments, the entries in the table 200H are vectorized prior to the calculation of the similarity measure. For example, in some embodiments, the vector representation of each snippet is determined when the snippet is entered into the repository and is stored alongside the index 202H and the snippet 204H. This vectorization allows for efficient comparison of the snippets with user queries, facilitating the retrieval of the most relevant code snippets.

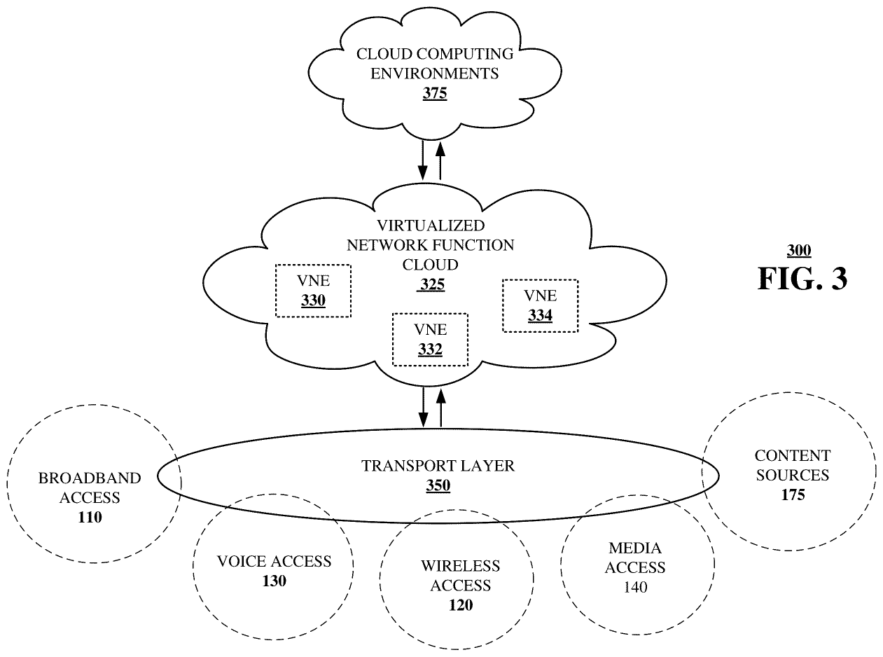

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part enhancing natural language response accuracy using AI models and similarity measures for efficient production and selection of contextually relevant answers.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

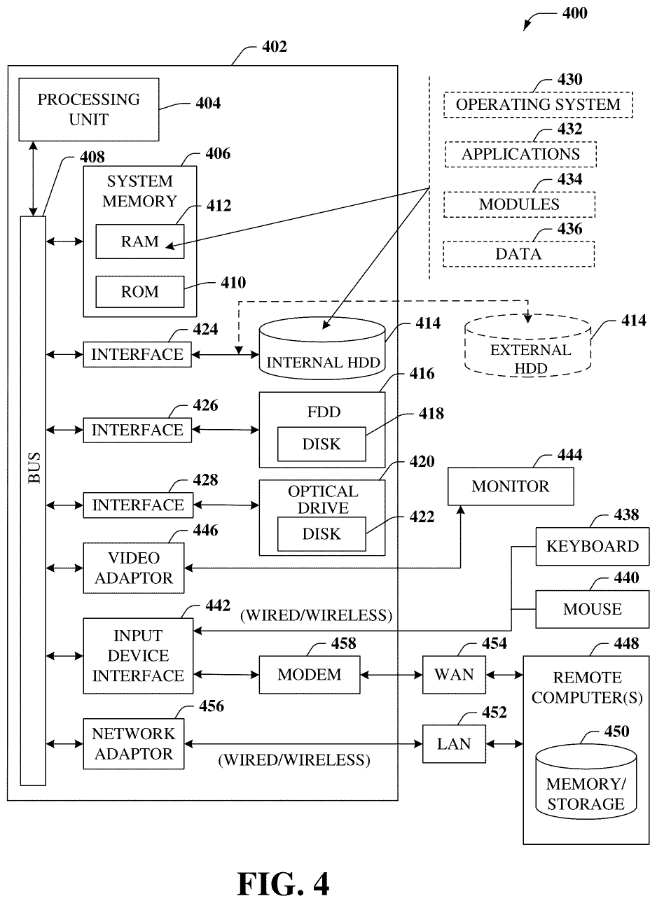

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part enhancing natural language response accuracy using AI models and similarity measures for efficient production and selection of contextually relevant answers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

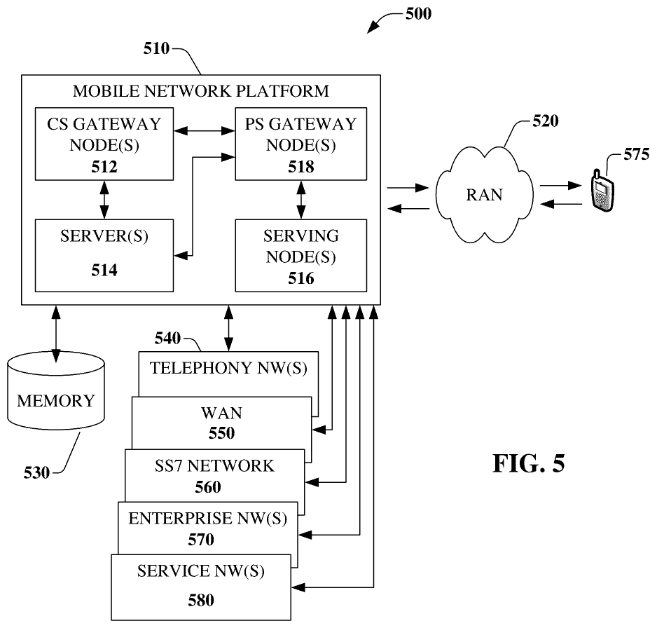

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part enhancing natural language response accuracy using AI models and similarity measures for efficient production and selection of contextually relevant answers. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

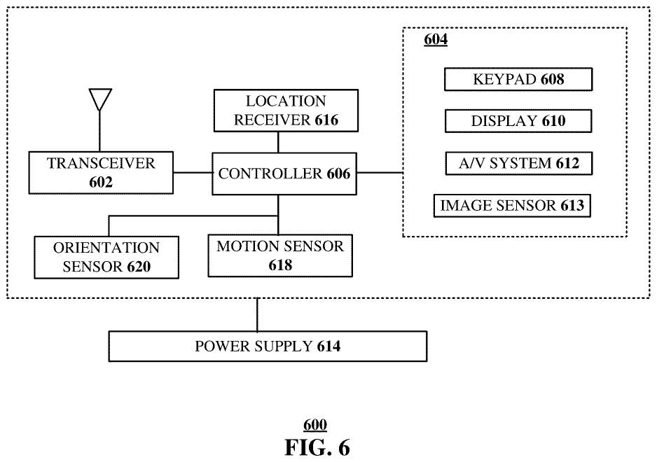

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part enhancing natural language response accuracy using AI models and similarity measures for efficient production and selection of contextually relevant answers.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
receiving, by the device, a user query;
retrieving, by the device from a data store, a set of potential answers to the user query;
calculating, by the device, a similarity measure between the user query and each potential answer from the set of potential answers;
selecting, by the device based on the similarity measure, N potential answers from the set of potential answers;
constructing, by the device, a prompt including the N potential answers, the prompt being constructed using a template that emphasizes one or more most relevant sections of the N potential answers, wherein the template associates each of the N potential answers with a respective identifier and includes instructions for an artificial intelligence (AI) model to output only an identifier corresponding to a selected potential answer of the N potential answers;
providing, by the device, the prompt to the AI model;
receiving, by the device from the AI model, the identifier corresponding to the selected potential answer from the N potential answers; and
generating, by the device, a response to the user query based on the selected potential answer, wherein the generating the response comprises outputting the selected potential answer corresponding to the identifier received from the AI model without altering the selected potential answer.

2. The device of claim 1, wherein the calculating the similarity measure comprises calculating a cosine similarity.

3. The device of claim 1, wherein the providing the prompt to an AI model comprises providing the prompt to a Generative Pretrained Transformer (GPT) model.

4. The device of claim 1, wherein the data store comprises a knowledge base that includes at least one text string.

5. The device of claim 1, wherein the data store comprises a knowledge base that includes a structured database.

6. The device of claim 1, wherein the calculating the similarity measure comprises term frequency-inverse document frequency (TF-IDF) scores to improve an accuracy of potential answer selection.

7. The device of claim 1, wherein the N potential answers are further filtered using a context-aware filtering mechanism that considers a semantic context of the user query.

8. The device of claim 1, wherein the data store includes metadata tagging to improve retrieval and ranking of potential answers.

9. The device of claim 1, wherein the data store includes computer code snippets.

10. The device of claim 1, wherein the data store includes archived technical support tickets.

11. A non-transitory machine-readable medium, comprising executable instructions that, when executed by a processing system including a processor, facilitate performance of operations, the operations comprising:
receiving, by the processing system, a domain specific user query;
retrieving, by the processing system from a domain specific knowledge base, a set of potential answers to the domain specific user query;
calculating, by the processing system, a similarity measure between the domain specific user query and each potential answer from the set of potential answers;
selecting, by the processing system based on the similarity measure, N potential answers from the set of potential answers;
constructing, by the processing system, a prompt including the N potential answers, the prompt being constructed using a template that emphasizes one or more most relevant sections of the N potential answers;
providing, by the processing system, the prompt to an artificial intelligence (AI) model;
receiving, by the processing system from the AI model, an identifier corresponding to a selected potential answer from the N potential answers; and
generating, by the processing system, a response to the domain specific user query based on the selected potential answer, wherein the generating the response comprises outputting the selected potential answer corresponding to the identifier received from the AI model without altering the selected potential answer.

12. The non-transitory machine-readable medium of claim 11, wherein the calculating the similarity measure comprises calculating a cosine similarity.

13. The non-transitory machine-readable medium of claim 11, wherein the providing the prompt to an AI model comprises providing the prompt to a Generative Pretrained Transformer (GPT) model.

14. The non-transitory machine-readable medium of claim 11, wherein the domain specific knowledge base comprises archived technical support tickets.

15. The non-transitory machine-readable medium of claim 11, wherein the domain specific knowledge base includes examples of computer code.

16. A method, comprising:
receiving, by a processing system including a processor, a domain specific user query;
calculating, by the processing system, a cosine similarity measure between the domain specific user query and each potential answer from a set of potential answers;
selecting, by the processing system and based on the cosine similarity measure, N potential answers from the set of potential answers;
constructing, by the processing system, a prompt including the N potential answers, the prompt being constructed using a template that emphasizes one or more most relevant sections of the N potential answers;
providing, by the processing system, the prompt to an artificial intelligence (AI) model;
receiving, by the processing system and from the AI model, an identifier corresponding to a most semantically relevant answer from the N potential answers; and
generating, by the processing system, a response to the domain specific user query based on the most semantically relevant answer, wherein the generating the response comprises outputting the most semantically relevant answer corresponding to the identifier received from the AI model without altering the most semantically relevant answer.

17. The method of claim 16, wherein the calculating the cosine similarity measure comprises including term frequency-inverse document frequency (TF-IDF) scores to improve an accuracy of potential answer selection.

18. The method of claim 16, wherein the N potential answers are further filtered using a context-aware filtering mechanism that considers a semantic context of the domain specific user query.

19. The method of claim 16, wherein the set of potential answers includes metadata tagging to improve retrieval and ranking of the potential answers.

20. The method of claim 16, wherein the calculating the cosine similarity measure is performed in a distributed computing environment.
